(19) United States
(12) Patent Application Publication
(10) Pub. No.: US 2005/0255926 A1
(43) Pub. Date: Nov. 17, 2005

(54) Star flexible coupling

(76) Inventors: Frank N. Piasecki, Haverford, PA (US); Frederick W. Piasecki, Haverford, PA (US); Dezi J. Folenta, Lincoln Park, NJ (US)

Correspondence Address: ROBERT S. LIPTON, ESQUIRE, 201 NORTH JACKSON STREET, P. O. BOX 934, MEDIA, PA, 19063-0934, US

(21) Appl. No.: 11/099,480

(22) Filed: Apr. 6, 2005

Related U.S. Application Data
(63) Continuation-in-part of application No. 10/188,253, filed on Jul. 3, 2002, now abandoned.

(51) Int. Cl. F16D 3/62

(52) U.S. Cl. 464/98

(57) ABSTRACT

Embodiments of the present invention relate to a flexible coupling for connecting a driving rotatable shaft to a driven rotatable shaft, where the flexible coupling allows greater relative misalignment and/or offset of the shafts compared to known couplings. The coupling may further enable control of torsional and axial stiffness.

This application is a continuation-in-part of U.S. application Ser. No. 10/188,253, filed Jul. 3, 2002 and fully incorporated herein by reference.

### BACKGROUND OF THE INVENTION

Mechanical couplings to transmit power from one shaft to another, where both shafts turn around the same nominal centerline, are known. Broadly speaking, types of known couplings include fixed-type and flexible-type couplings.

Flexible-type couplings may be particularly appropriate for use with shafts that have some angular misalignment relative to each other, have a small parallel offset relative to each other, or have both an angular misalignment and parallel offset relative to each other. More specifically, the misalignment and/or offset may exist with respect to respective theoretical centerlines of coupled shafts.

Crown splines, flexible disks and diaphragm-type couplings are examples of known techniques for accommodating shaft misalignment and/or offset. However, one disadvantage of such known arrangements is that they severely limit the shaft misalignment/offset possible.

### BRIEF DESCRIPTION OF THE DRAWINGS

FIG. 1 is an exploded cross-sectional view of a coupling according to embodiments of the present invention;

FIG. 2 is an end view showing a cross-section of element 10 from the perspective of line 2-2 of FIG. 1;

FIG. 3 is an end view of a spool of the coupling from the perspective of line 3-3 of FIG. 1;

FIG. 4 is a cross-sectional view of an assembled coupling according to embodiments of the present invention; and

FIGS. 5 and 6 illustrate the application of forces to the coupling according to embodiments of the present invention.

### DETAILED DESCRIPTION

Embodiments of the present invention overcome several of the disadvantages of known couplings. The embodiments relate to a flexible coupling for connecting a driving rotatable shaft to a driven rotatable shaft, where the flexible coupling allows greater relative misalignment and/or offset of the shafts compared to known couplings. The coupling may further enable control of torsional and axial stiffness.

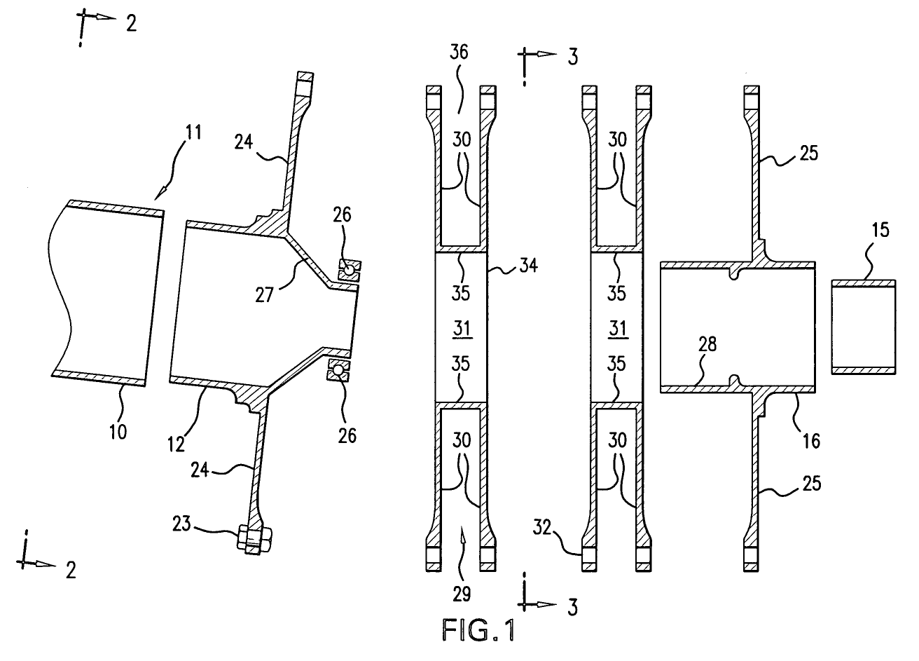

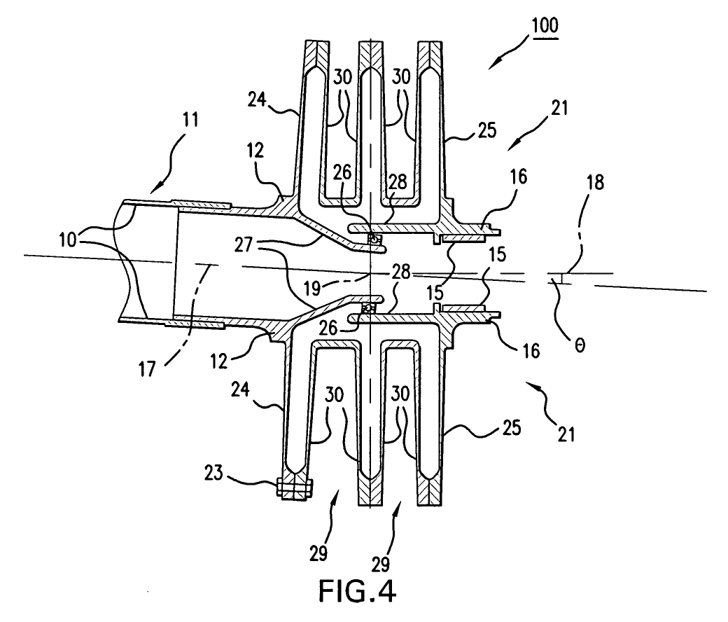

FIG. 1 shows an exploded view of a cross section of a flexible coupling 100 according to embodiments of the present invention. FIG. 4 shows the same cross section of the flexible coupling 100 of FIG. 1, where the coupling is in an assembled form.

The coupling 100 may comprise a driving hub 12 adapted to be coupled to a rotatable driving shaft 11. For example, the driving hub 12 could be received within, bolted to or otherwise fastened to an end 10 of the rotatable driving shaft 11. The driving hub 12 may have a plurality of arms 24.

A driven hub 16 may be adapted to be coupled to a driven shaft 15. For example, the driven shaft 15 could be shrunk-fit to or otherwise fastened to the driven hub 16. The driven hub end 16 may have a plurality of arms 25.

The coupling may further comprise a plurality of spools 29. Each spool may include a plurality of arms 30 and an opening 31 therethrough. The plurality of arms 30 may be symmetrically arranged about each of opposing faces 34 of a spool hub 35, and separated by a space 36.

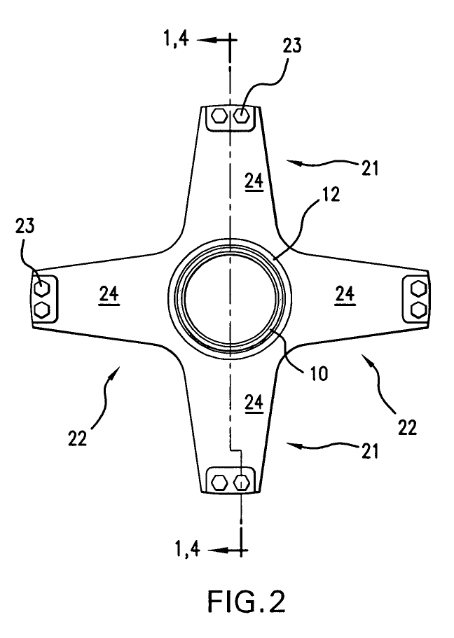

FIG. 2 shows a an end view from the perspective of line 2-2 of FIG. 1, i.e. a view from an input or driving side of the coupling. As can be seen in FIG. 2, the driving hub arms 24 extend radially about an outer periphery of the driving hub 12, forming a “star” shape. Arm sets 21, 22 may be substantially perpendicular to each other. However, the number of arms 24 is not limited to four as in FIG. 2; there could be more or fewer. In such embodiments (e.g. an embodiment with three arms, or five, etc.), arm sets would not be perpendicular to each other.

In FIG. 2, the arms 30 of the spools 29 and the arms 25 of the driven hub 16 are not visible. This is in order to illustrate that, in an orthogonal face or end view as in FIG. 2, the driving hub 12 with arms 24, the spools 29 with arms 30, and the driven hub 16 with arms 25 may essentially be mirror images of each other, i.e., have the same or substantially the same shape and dimensions in outline. Thus, FIG. 2 is not strictly accurate in that FIGS. 1 and 4 show a misalignment or angular displacement between the driving shaft and the driven shaft, and the corresponding hubs and spools, which would mean that the faces of the spools and driven hub would not necessarily be in the same plane as FIG. 2 and thus might be partly visible. However, if substantially aligned, each of the driving hub 12 with arms 24, the spools 29 with arms 30, and the driven hub 16 with arms 25 may have the same or substantially the same shape and dimensions in outline.

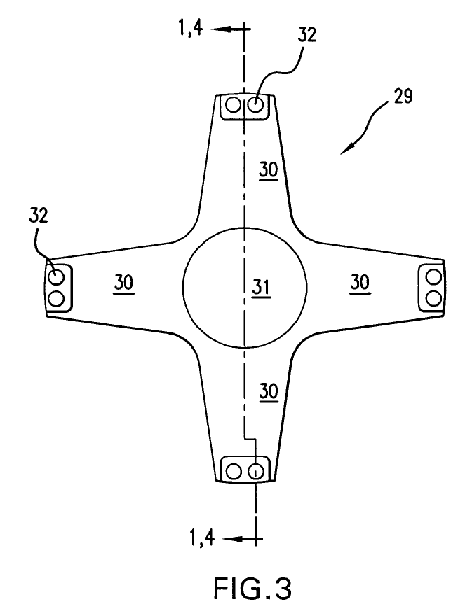

FIG. 3 shows a face or end view of one of the spools 29 from the perspective of line 3-3 of FIG. 1. When the flexible coupling 100 is assembled, opening 31 in the illustrated spool 29 may receive therein a hub portion, such as an inner extension 28 of the driven hub 16 (see FIG. 1). Similarly, the opening 31 of the other spool 29 may receive therein an inner extension 27 of the driving hub 12 when the flexible coupling 100 is assembled. Both of the spools 29 of FIG. 1, however, may have the same structure and be interchangeable. Holes 32 in ends of the arms 30 of the spools 29 may be adapted to receive fastening bolts therethrough.

As noted above, FIG. 4 shows a cross-sectional view of the flexible coupling 100 assembled. In an assembled form, the driving hub arms 24 may be fastened to a first set of corresponding arms 30 of an adjacent first spool 29, for example by bolts 23. It should be understood that bolts 23 are not the only attachment mechanism possible. Any suitable attachment mechanism, such as welds, keys or splines could also be used to fasten arms 24, 30, 25 of the coupling 100 together.

A second set of arms 30 of the adjacent first spool 29, arranged about an opposing face of a hub of the first spool, may in turn be fastened to corresponding arms 30 of an adjacent second spool 29. Arms 30 of the second spool 29 arranged about an opposing spool hub face thereof may in turn be fastened to corresponding arms 25 of the driven hub 16. The flexible coupling 100 is not limited to two spools; there may be more or fewer.

The driving hub 12 is coupled to the driving shaft 11, and the driven hub 16 is coupled to the driven shaft 15. An axial misalignment exists between the driving shaft 11 and the driven shaft 15, as illustrated by a displacement angle θ between a longitudinal axis 17 of the driving shaft 11 and a longitudinal axis 18 of the driven shaft 15.

In operation of the flexible coupling 100, power from the driving shaft 11 is delivered to the driving hub 12. The power flows from the driving hub 12 into its arms 24, and from the arms 24 into the first adjacent spool 29. The power continues to flow from the first adjacent spool 29 to the second adjacent spool 29 fastened to the driven hub 16, and from there to the driven shaft 15.

A rolling contact 26 (e.g. a ball or roller bearing) is located along a line passing through a common point 19 defining an intersection between the longitudinal axis 17 of the driving shaft 11 and the longitudinal axis 18 of the driven shaft 15. The driving hub 12 and driven hub 16 may be coupled together along the line passing through the common point 19, to prevent flailing of the flexible coupling 100. This feature may also significantly increase the speed capacity of the flexible coupling 100. In embodiments, the inner extension 27 of the driving hub 12 may have a conical shape whose end fits within the inner extension 28 of the driven hub. The rolling contact 26 may be in supporting contact with both the inner extension 27 and the inner extension 28 where a portion of the inner extension 28 overlaps the inner extension 27 along the line passing through the common point 19. It should be understood that the foregoing is not the only way to bring the driving hub and driven hub into contact with each other; other ways are possible. For example, in alternative embodiments the roles of the respective inner extensions 27, 28 could be reversed: i.e., an inner extension of the driven hub could fit within an inner extension of the driving hub.

A property of the flexible coupling 100 according to embodiments of the present invention that may enable the displacement angle θ to be greater than in conventional arrangements, while still allowing proper and efficient operation of the coupling, is a combination of axial flexibility with torsional stiffness. To this end, the arms 24, 30 and 25 of the coupling may be bendable or flexible in an axial direction, while being stiff in a torsional direction. “Axial direction” as used here means in a direction parallel or approximately parallel to one of the longitudinal axis 17 of the driving shaft 11 or the longitudinal axis 18 of the driven shaft 15. “Torsional direction” means in a same or approximately same direction as a direction of a force to cause rotation of the driving shaft 11 or driven shaft 15.

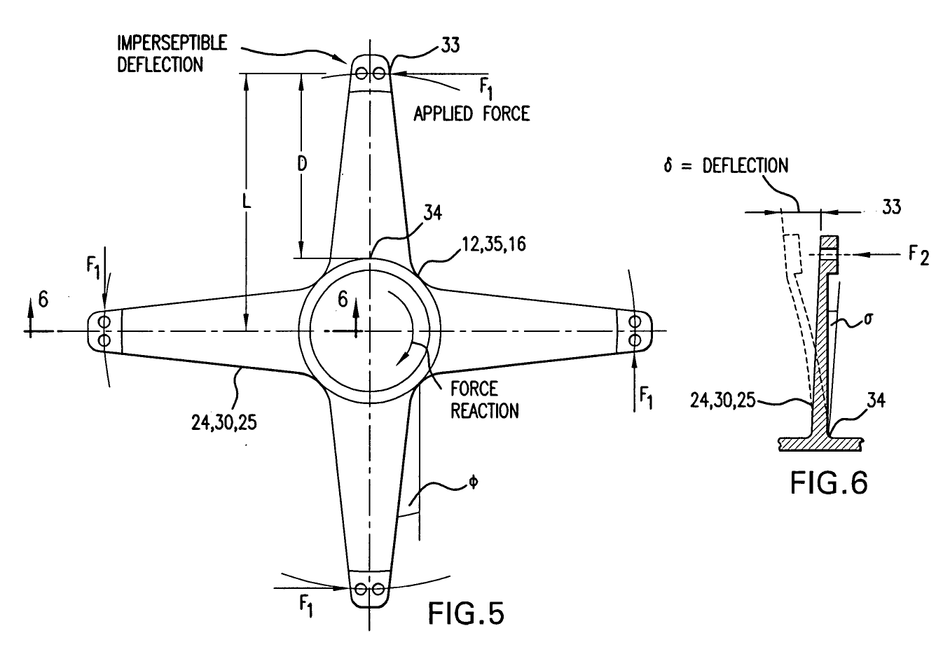

FIGS. 5 and 6 further illustrate the principle of axial flexibility with torsional stiffness provided by a flexible coupling according to embodiments of the present invention. FIG. 5 shows a face or end view that could correspond to any of the driving hub 12 with arms 24, a spool hub 35 with arm 30, or the driven hub 16 with arms 25. A force F1 applied in a torsional direction to ends of arms 24, 30, 25 may deflect the arms almost imperceptibly. On the other hand, a force F2 applied in an axial direction as shown in FIG. 6 deflects an arm 24, 30, 25 by a deflection S which may be orders of magnitude greater than any deflection in the orthogonal plane of FIG. 5.

A plurality of structural features of the coupling 100 may be adjustable to meet desired ranges for the displacement angle θ or other parameters. For example, to increase angular misalignment to a greater angle θ, a number of spools 29 between the driving hub 12 and the driven hub 16 could be increased. On the other hand, spools 29 could be eliminated altogether and the driving hub 12 could be connected directly to the driven hub 16 if the input (driving) shaft and the output (driven) shaft were in good alignment and anticipated thermal growth of the connecting shafts was in an acceptable range.

To increase axial flexibility and reduce torsional stiffness, a number of arms 24, 30 and 25 could be reduced. To increase axial and torsional stiffness, a number of spools 29 between the driving hub 12 and the driven hub 16 could be decreased and a number of arms 24, 30, and 25 could be increased.

Other structural features that could be used to control axial flexibility and torsional stiffness include a length, width and thickness of the arms 24, 30, 25, and a degree of taper in the arms. By way of explanation, assume a first flexible member with a fixed end and an unfixed end. The unfixed end is a distance D1 from the fixed end. Further assume a second flexible member with a fixed end and an unfixed end, where the unfixed end is a distance D2 from the fixed end, and where D2 is greater than D1. It is well understood that if the same force is applied to both the unfixed end of the first flexible member and the unfixed end of the second flexible member, the unfixed end of the second flexible member will be deflected further than the unfixed end of the first flexible member. Similarly, the unfixed end of a flexible member that becomes wider toward the fixed end than does another flexible member will be deflected less by the same force.

In view of the above, and referring now to FIGS. 5 and 6, a magnitude of the deflection δ may be controlled by an arm length, width and degree of taper (noting that taper corresponds directly to length and width). In FIG. 5, the arm length is indicated by two measures, D and L. D is a distance between an unfixed point 33 at an arm end where a torsional force F1 and an axial force F2 are applied, and a fixed point 34 at the hub body. L is D plus a hub radius. A magnitude of the deflection δ may further be controlled by a degree of taper φ in an arm in a radial plane, i.e., a plane substantially parallel to the plane of FIG. 5, and a degree of taper a in an arm in an axial plane, i.e., a plane substantially parallel to the plane of FIG. 6.

Thus, a flexible coupling according to embodiments of the present invention can readily meet particular applications by any one, or any combination of, adding or eliminating spools and/or arms, and increasing or decreasing D/L and/or φ and/or σ.

An additional advantage provided by the structure of the flexible coupling 100 is that a failure of any one of the connecting bolts, arms or spools will immediately unbalance the drive system and alert an operator. At the same time, the redundancy in the coupling structure, i.e., the other arms, spools and so on, will permit the shafting to continue to safely transmit power.

In summary, the foregoing describes a flexible coupling 100 with increased angular misalignment capacity, and increased safety due to a multiplicity of redundant drive paths (e.g. multiple arms). The redundant drive paths provide the ability to detect problems while continuing to transmit power safely. Further, by judiciously varying arm width, taper and thickness, constant stress (strength) within the arms, and the ability to control axial and torsional stiffness as described above, can be achieved. An anti-flailing feature is provided by the rolling contact along the line through the common point 19 as further described above. The materials of the flexible coupling 100 may be lightweight for improved flexibility and performance. Those skilled in the field of the present invention will further appreciate that the flexible coupling 100 has an advantageous simplicity of design and commonality of parts (e.g., redundant, interchangeable spools as described above).

Several embodiments of the present invention are specifically illustrated and described herein. However, it will be appreciated that modifications and variations of the present invention are covered by the above teachings and within the purview of the appended claims without departing from the spirit and intended scope of the invention.

1. A flexible coupling for coupling together a pair of misaligned shafts, comprising:
a driving hub to couple to a driving shaft, the driving hub having a plurality of flexible arms;
a driven hub to couple to a driven shaft, the driven hub having a plurality of flexible arms corresponding to the plurality of flexible arms of the driving hub; and
a spool having a plurality of flexible arms corresponding to the plurality of flexible arms of the driving hub and the driven hub, for coupling the spool between the driving hub and the driven hub.

2. The flexible coupling of claim 1, wherein the arms are radially arranged about respective outer peripheries of the driving hub, driven hub and spool.

3. The flexible coupling of claim 1, wherein the driving hub, driven hub and spool have a same shape in an outline thereof.

4. The flexible coupling of claim 1, wherein an arm of any of the driving hub, driven hub or spool tapers in a radial plane.

5. The flexible coupling of claim 1, wherein an arm of any of the driving hub, driven hub or spool tapers in an axial direction.

6. The flexible coupling of claim 1, wherein the arms are flexible in an axial direction.

7. The flexible coupling of claim 1, wherein the arms are stiff in a torsional direction.

8. A flexible coupling for coupling together a pair of misaligned shafts, including:
a driving hub;
a spool; and
a third member;
the driving hub comprising a plurality of radially arranged, flexible arms, the driving hub arms each connected to a corresponding arm of a first set of flexible arms of the spool, the first set of arms being symmetrically arranged about one of opposing faces of a spool hub, the spool further comprising a second set of flexible arms symmetrically arranged about the other opposing face of the spool hub, the seconds set of flexible arms each connected to corresponding flexible arms of the third member.

9. The flexible coupling of claim 8, wherein the third member is a spool.

10. The flexible coupling of claim 8, wherein the third member is a driven hub.
